(19) United States
(12) Patent Application Publication
(10) Pub. No.: US 2005/0049771 A1
(43) Pub. Date: Mar. 3, 2005

(54) System and method for improving driveability and performance of a hybrid vehicle

(76) Inventors: Ming Kuang, Canton, MI (US); Mary Breida, Ann Arbor, MI (US)

Correspondence Address: FORD GLOBAL TECHNOLOGIES, LLC., SUITE 600 - PARKLANE TOWERS EAST, ONE PARKLANE BLVD., DEARBORN, MI, 48126, US

(21) Appl. No.: 10/648,899

(22) Filed: Aug. 27, 2003

(51) Int. Cl. G06F 7/00

(52) U.S. Cl. 701/51

(57) ABSTRACT

A control method and system for propelling a vehicle includes a primary power source for propelling the vehicle at a time after the vehicle is initially propelled, and a secondary power source for initially propelling and accelerating the vehicle prior to activation of the primary power source. A controller determines a weight of the vehicle based on the initial acceleration of the vehicle, and a driver torque request. The controller activates the primary power source when the weight of the vehicle exceeds a predetermined threshold vehicle weight value and the driver torque request exceeds a predetermined threshold torque value.

### BACKGROUND OF THE INVENTION

1. Field of the Invention

The present invention relates generally to a method for controlling an automotive vehicle having multiple driving power sources. More particularly, the invention relates to a method for improving drivability and performance during the start-up of a hybrid vehicle's primary power source.

2. Background Art

Vehicles having so-called “hybrid” powertrains utilize multiple power sources for generating a demanded torque or drive force for a vehicle. Such hybrid powertrains include configurations of internal combustion engines (ICE's), electric machines and even fuel cell engines for propelling the vehicle as required by an operator. Well known configurations include so-called series, parallel and parallel-series hybrid configurations, in which typically a conventional internal combustion engine is coupled with one or more electric machines and high voltage battery system to deliver a required amount of mechanical energy required to propel the vehicle. See for example U.S. Pat. Nos. 6,494,277 and 6,196,344, which are owned by the present assignee and hereby incorporated by reference in their entireties. These powertrains generally provide start/stop, regenerative braking and boost capabilities, which allow for significantly improved fuel economy, lower emissions and improved performance as compared to conventional non-hybrid powertrain systems

Hybrid vehicles achieve improved fuel economy, emissions and performance by utilizing control strategies that take advantage of the characteristics of the individual power generating sources. For example, operating a hybrid ICE-driven vehicle in an “electric propulsion mode” using one or more electric machines is advantageous during launch or reverse operation because of the system's ability to deliver high torque at low speeds with high efficiency. Operation of the ICE is reserved for situations where driving conditions, such as high load and high speed condition, allow for optimal efficiency and lower emissions.

Therefore, a challenge with hybrid vehicles is the ability to coordinate the delivery of power from each of the individual power sources in accordance with an energy management strategy that is responsive to driver demand while optimizing the use of each of the individual power sources. For a given driver demand, the control strategy must not only determine when and how much power each source delivers to the drivetrain, but must also coordinate such power delivery in a manner that is imperceptible to the driver.

The situation referred to above, in which one or more electric machines is used during launch, creates an additional challenge of filling in “torque holes” created when a main power source is eventually started or restarted. A torque hole, or temporary drop-off in actual drive force, may be perceived by the operator as the delivery of requested drive force transitions from one power source, such as an electric machine/battery, to another power source, such as an ICE or fuel cell engine. Such torque holes may be further amplified when the vehicle is carrying a heavy payload, traveling uphill or otherwise subjected to sudden vehicle load changes.

As such, the inventors herein have recognized the need to optimize control of a hybrid vehicle so as to minimize the effects of torque holes during start-up of the primary power source.

### SUMMARY OF THE INVENTION

A system for propelling a vehicle is disclosed that substantially overcomes the limitations and shortcomings of known hybrid powertrain systems. In accordance with one embodiment of the present invention, the system includes a primary power source for propelling the vehicle at a time after the vehicle is initially propelled or accelerated, and a secondary power source for initially propelling and accelerating the vehicle prior to activation of the primary power source. A controller is provided for determining a weight of the vehicle based on the initial acceleration of the vehicle, and for determining a driver torque request. The controller then activates the primary power source when the weight of the vehicle exceeds a predetermined threshold vehicle weight value and the driver torque request exceeds a predetermined threshold torque value. The primary power source, for example, can be an internal combustion engine, or even a fuel cell engine. The secondary power source may include a high voltage battery electrically coupled to one or more electric motor/generators.

In accordance with a related aspect of the present invention, a method of operating a vehicle having a plurality of power sources for propelling the vehicle is disclosed, the method including the steps of using one of the power sources (e.g., a “secondary” power source) to initially accelerate the vehicle, determining a vehicle weight based on the initial acceleration of the vehicle, determining a driver torque request, and activating another of the power sources (e.g., the “primary” power source) when the weight of the vehicle exceeds a predetermined threshold vehicle weight value and the driver torque request exceeds a predetermined threshold torque value.

Preferably, in a system having at least a motor as the secondary power source, initial acceleration of the vehicle is estimated as function of a change in rotational speed of the motor. The estimated initial acceleration is then used to estimate the total traction force at the drive wheels, and the estimate of total traction force used to estimate the weight of the vehicle.

By comparing the vehicle weight and driver demanded torque to predetermined threshold values, the starting of the primary power source is controlled to occur when the motor has sufficient torque capacity to be controlled in a manner that negates opposing torque effects imposed by starting the engine. This serves to minimize the effects of torque holes thereby improving driveability and performance during start-up of the primary source. The claimed method is especially advantageous when the vehicle is carrying a heavy payload, traveling uphill or otherwise subjected to sudden vehicle load changes.

Further advantages, objectives and features of the invention will become apparent from the following detailed description and the accompanying figures disclosuing illustrative embodiments of the invention.

### BRIEF DESCRIPTION OF THE DRAWINGS

For a complete understanding of the present invention and the advantages thereof, reference is now made to the following description taken in conjunction with the accompanying drawings wherein:

FIG. 1 is a schematic block diagram of a hybrid powertrain system having a plurality of power sources for propelling a vehicle;

FIGS. 2a through 2d are schematic block diagrams that illustrate examples of various hybrid powertrain configurations related to the present invention;

FIG. 3 is detailed schematic diagram of an exemplary hybrid powertrain related to the present invention;

FIG. 4 is a flow diagram of a control routine used in practicing a method according to the present invention; and

FIG. 5 is a flow diagram of the method of FIG. 4 adapted to control the hybrid powertrain of FIG. 3.

### DETAILED DESCRIPTION OF THE PREFERRED EMBODIMENTS

The invention described herein is a system and corresponding methods for operating a hybrid electric vehicle during activation of a vehicle's primary power source; for example, after a start/stop event during which the primary power source is temporarily deactivated. The method described herein is applicable but not limited to hybrid vehicle systems, and is not limited in any way to a specific construction or configuration of the vehicle or its powertrain.

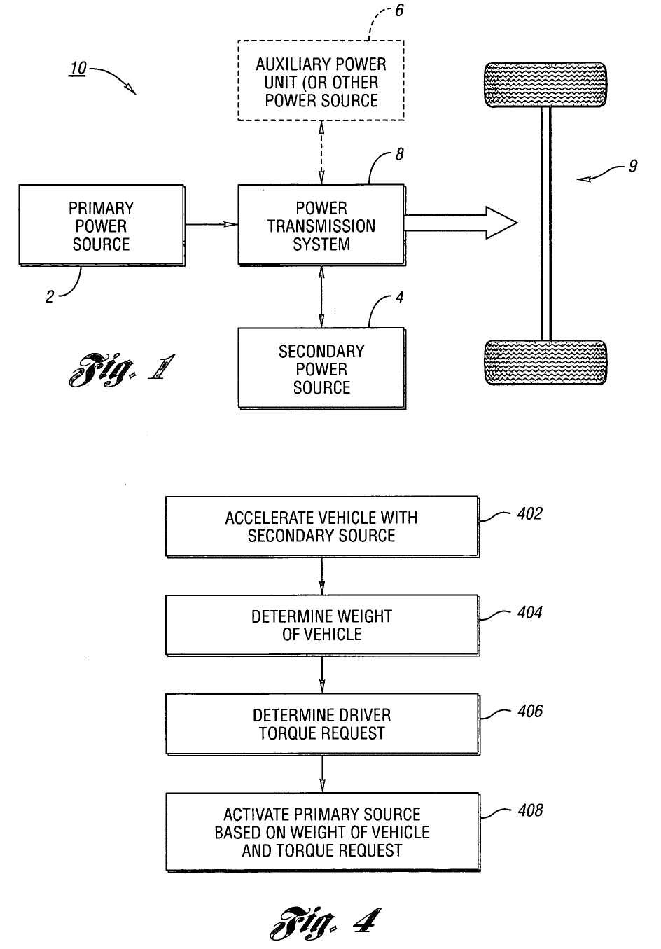

FIG. 1 shows generally a hybrid vehicle system to which the present invention may be applicable. The system 10 includes a primary power source 2, a secondary power source 4, an auxiliary power unit (APU) or other power sources 6, and a power transmission system 8 for delivering drive torque to drive wheels 9 of the vehicle. The primary source 2 may include, for example, a liquid or gas-fuel internal combustion engine (ICE), or alternatively a hydrogen fuel cell engine. The secondary power source 4 may include a battery or an ultracapacitor for storing electrical energy; or alternatively, an accumulator for storing mechanical energy. The APU/other power source 8 may include any of the above-referenced electrical or other energy storage devices, and it is understood that any such devices can be interchanged as the primary, secondary or auxiliary power sources. The power transmission unit 8 may include any suitable power transmission system for converting electrical and/or mechanical power from any of the power sources 2, 4 and 6 to generate a sufficient level of drive force in order to propel the vehicle.

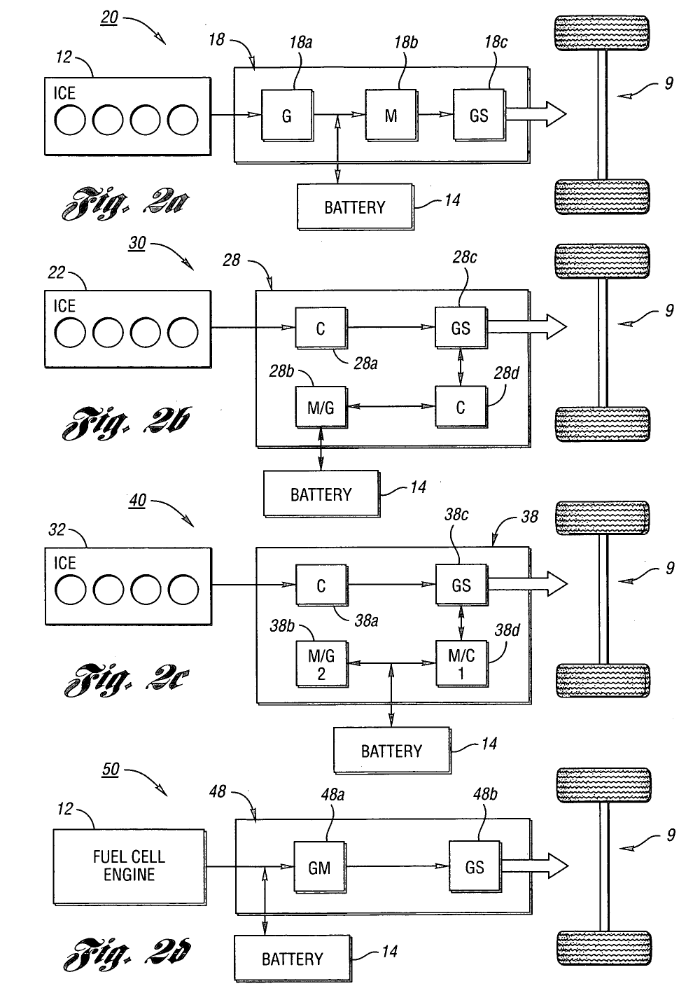

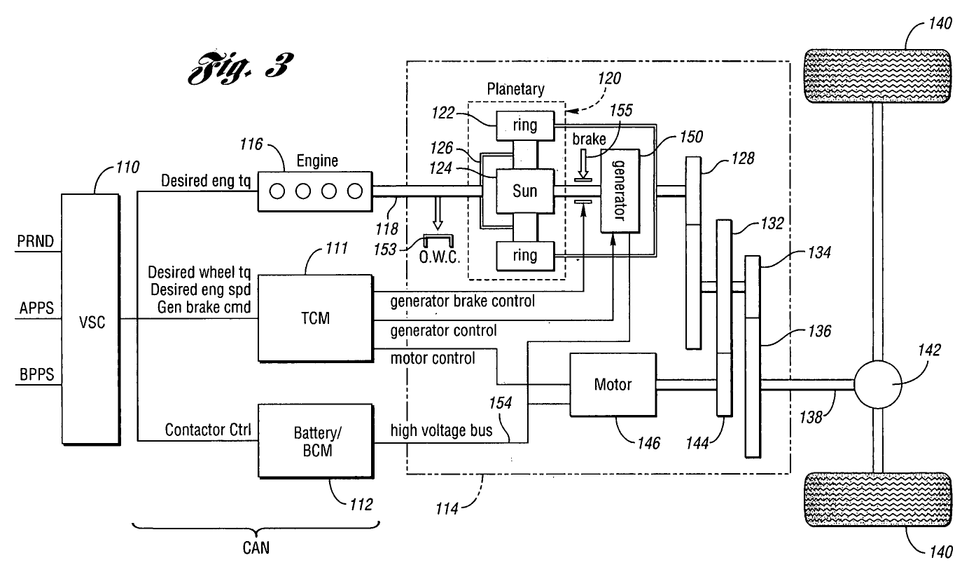

FIGS. 2a through 2d show various examples of hybrid powertrain systems and corresponding power transmission units. FIG. 2a shows a so-called series hybrid configuration 20 having a power transmission unit 18, wherein an ICE rotates a generator 18a, which in turn produces electrical energy for powering the vehicle drive wheels 9 via the motor 18b and a gearset 18c, or for storage in battery 14. FIG. 2b shows a parallel hybrid configuration 28 and power transmission unit 28, wherein power is delivered via a first path having an ICE 22, a coupling device 28a, and a gearset 28c, and/or a second path having a motor/generator 28b, a coupling device 28d and the gearset 28c. The coupling devices 28a and 28d can be any suitable device, for example a gearset or clutch, for transmitting mechanical energy to the vehicle drive wheels 9. FIG. 2c shows a so-called “parallel-series” configuration 30 having a power transmission unit 38, wherein motor/generators 38b and 38d are either mechanically or electrically coupled, for example via a planetary gearset 38a, to deliver power to a gearset 38c and drivetrain 9. FIG. 2d shows a further exemplary configuration utilizing a fuel cell engine, for example a Mark 900 Fuel Cell Stack Module manufactured by Ballard Power Systems, having an integrated power transmission unit 48 containing a motor 48a and a gearset 48b.

FIG. 3 is detailed schematic diagram of an exemplary hybrid powertrain to which the present invention can be applied. As shown in FIG. 3, the HEV powertrain configuration 100 includes a gasoline-fueled internal combustion engine (ICE) 116, an electronically controlled power transmission unit 114, vehicle system controller (VSC) 110, a power transmission unit controller 111, and a high voltage battery system 112. The ICE 116 and battery system 112 are coupled to the vehicle driveline through power transmission unit 114, which includes a first motor/generator (MG1) 150 functioning primarily as a generator and a second motor/generator (MG2) 146 functioning primarily as a motor. The battery system serves primarily as an energy storage device to store electrical energy produced by MG1, and for electrically powering MG2.

Note, the ICE 116 is generally referred to as “the primary power source,” and the combination of the battery 112, MG1 150 and MG2 146 is collectively referred to as “the secondary power source.” It is understood however that the primary and secondary sources can be interchanged. The primary power source, for example, can be any internal combustion engine, including but not limited to gasoline, diesel, hydrogen, methanol, natural gas, methanol or other gas or liquid-fueled internal combustion engine or combination thereof. Alternatively, the primary power source can be a fuel cell engine, such as a hydrogen-powered fuel cell engine. The secondary power source may also include ultracapacitors, linear generators and other electro-mechanical or hydraulic devices for generating torque.

Referring again to FIG. 3, the power transmission unit 114 includes a planetary gearset 120, which includes a ring gear 122, a sun gear 124 and a planetary carrier assembly 126. The ring gear 122 couples MG2 to the vehicle drivetrain via step ratio gears/meshing gear elements 128, 130, 132, 134 and 136. Sun gear 124 and planetary carrier assembly 126 likewise couple the ICE and MG1, respectively, to the vehicle traction wheels 140 and differential and axle mechanism 142 via a torque output shaft 138 of the power transmission unit 114. Gears 130, 132 and 314 are mounted on a countershaft, the gear 132 engaging a motor-driven gear 144. Electric motor 146 drives gear 144, which acts as a torque input for the countershaft gearing.

Via the VSC 110, the HEV powertrain 100 can be operated in a number of different power “modes” utilizing one or more of the ICE, MG1 and MG2. Some of these modes, described generally as “parallel,” “split” and “electric,”, are described for example in U.S. patent application Ser. No. 10/248,886, which is owned by the present assignee and hereby incorporated by reference in its entirety. One of these modes, the “electric vehicle” (EV) or “electric drive mode,” is established when the ICE is shut off and a one-way clutch 153 engaged for braking the torque input 118 and the carrier assembly 126. This leaves the vehicle in EV mode, wherein tractive force is delivered only by an electric propulsion system comprised of the battery system 112 and one or both of the motor/generators MG1 and MG2.

Operation in EV mode is especially advantageous when the commanded power is low enough so that it can be produced more efficiently by the electric propulsion system (MG2 and battery) than by the ICE. One such situation occurs under “drive away” or “launch” conditions, when it is preferable to operate the vehicle in EV mode due to the ICE not being in an optimal operating state.

In accordance with the present invention, the motor/generator MG1 can also be used to “assist” the vehicle launch so as to improve the acceleration performance of the vehicle. This can be achieved, for example, by using the motor/generator MG1 to crank the ICE to a target speed after the vehicle has accelerated to a predetermined speed. During the cranking process, however, the vehicle may be susceptible to a “torque holes” caused by the reaction of engine cranking torque at the ring gear of the planetary gearset (which couples the motor/generator MG2 to the rest of the powertrain system). Since the motor/generator MG2 is coupled to the ring gear, the reaction energy of the cranking torque will act against the drive torque produced by MG2 for accelerating the vehicle. This will create a “torque hole,” or a temporary reduction or discontinuity in vehicle acceleration, which may be perceived by a vehicle operator during launch.

In addition, torque holes may be more pronounced when a vehicle is carrying or pulling a heavy payload, or when it is traveling uphill. As such, a nominal engine starting strategy may not be desirable since the drivability and acceleration performance of the vehicle will be degraded.

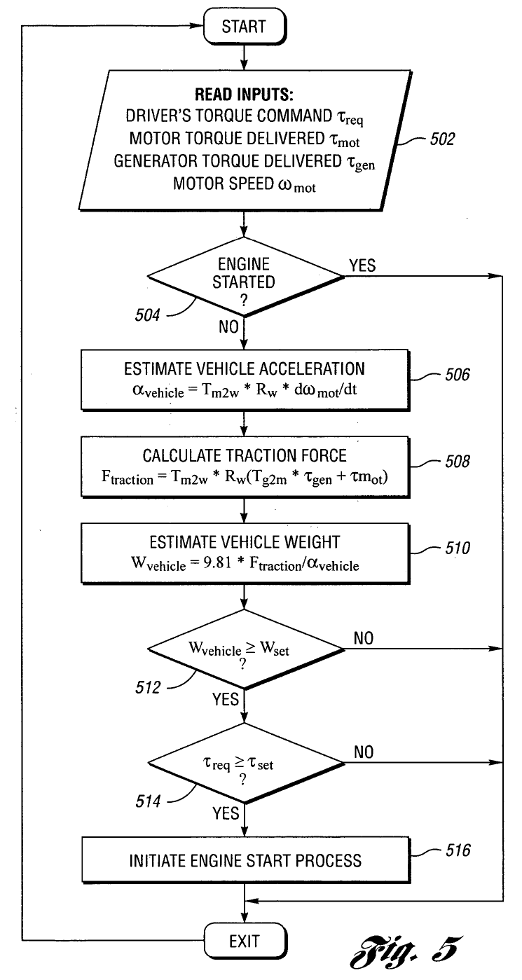

The present invention is now described with reference to FIG. 4 and the parallel-series configuration of FIG. 3. The parallel-series configuration of FIG. 3 however is not intended to limit the scope of the present invention. FIG. 4 shows a control routing used in method according to the present invention for operating a vehicle having at least a primary power source, such as an internal combustion engine or fuel cell engine, and a secondary power source, such as battery in combination with one or more electric machines. The method, in its broadest form, includes the steps of using the secondary power source to initially accelerate the vehicle (Step 402), determining a weight of the vehicle based on the initial acceleration of the vehicle (Step 404) either by direct measurement or computation of an operating parameter, such as rotational speed, of the secondary power source, determining and/or obtaining a driver torque request (Step 406) for example via an accelerator position pedal or other actuator or by computation, and activating the primary power source when the weight of the vehicle exceeds a predetermined threshold vehicle weight value and the driver torque request exceeds a predetermined threshold driver torque request value (Step 408).

In one embodiment of the present invention, the determined vehicle weight, which varies based on mechanical load and driving surface grade, is compared to a so-called “flat road” weight of the vehicle. The “flat-road” (threshold) vehicle weight depends in part on the size of the vehicle and its powertrain capabilities, and can be determined experimentally so as to minimize the undesired effects of torque holes on vehicle drivability and performance. Preferably, the threshold vehicle weight corresponds to weight of the nominally loaded vehicle on a flat surface. The threshold weight however is calibratable and can vary according to anticipated usage of the vehicle, e.g., towing versus non-towing applications, on-road versus off-road applications, etc. The threshold driver torque request value is also calibratable and determined experimentally.

FIG. 5 shows another preferred method of the present invention as applied to the HEV powertrain configuration of FIG. 3. As implemented in the VSC 110, the method includes the initial step (Step 502) of determining one or more of the following: a driver torque command τ_{req}, a torque τₘₒₜ delivered by the motor MG2, a torque τ_{gen} delivered by the generator MG1, and the rotational speed ωₘₒₜ of the motor. As can appreciated by those skilled in the art, the demanded or requested torque τ_{req} can be determined at least in part by sensing the position of an accelerator pedal or other actuator or control device. The accelerator pedal position, for example, can be used together with a measured vehicle speed to derive a requested torque τ_{req}. Alternatively, one or more look-up tables can be used that take into account various other parameters including the sensitivity of the pedal, maximum torque capacity of the system and driveability of the vehicle. The VSC or transaxle/power transmission unit controller then arbitrates the torque request and determines the torque components τₘₒₜ and τ_{gen} to be delivered by the motor MG2 and generator MG2, respectively. The VSC monitors the motor speed ωₘₒₜ in a known manner using for example one or more speed sensors coupled to the motor. Preferably, to increase accuracy of the reading, the motor speed ωₘₒₜ is filtered or otherwise sampled and averaged over a predetermined period of time.

Next, the internal combustion engine run status is checked (Step 504) to determine whether the engine is stopped or running. If the engine is running, then the control method exits. If the engine is not running, the control logic then estimates the initial acceleration of the vehicle α_{vehicle} as a function of the change in the rotational speed dωₘₒₜ/dt of the motor MG2:
α_{vehicle}=T_{m2w}*R_{w}*dωₘₒₜ/dt (Equation 1)
The initial acceleration of the vehicle α_{vehicle} is understood to be the acceleration of the vehicle resulting from application of the motor torque τₘₒₜ and any supplemental torque τ_{gen} (generator assist) delivered by the generator MG1. T_{m2w} is the gear ratio from the motor MG2 to the drive wheels 140, and R_{w} is the radius of the drive wheels 140.

Alternatively, as can be appreciated by one skilled in the art, the initial vehicle acceleration (α_{vehicle}) can be measured directly through the use of one or more accelerometers or similar devices capable of sensing acceleration and forces associated with the vehicle's acceleration. One or more accelerometers, or alternatively one or more torque sensors mounted on the vehicle axles or half-shafts, can be used to derive vehicle acceleration.

According to the next step (Step 506) of the present invention, the VSC then applies Equation 2 to determine a total traction force F_{traction}. at the drive wheels:
F_{traction}=T_{m2w}*R_{w}*(T_{g2m}*τ_{gen}+τₘₒₜ) (Equation 2)
where T_{m2w} is the gear ratio from the generator MG1 to the motor MG2, and R_{w} (as described above) is the radius of the drive wheels.

The weight W_{vehicle} of the vehicle 10 is then determined (Step 510) by applying Equation 3:
W_{vehicle}=9.81*F_{traction}/α_{vehicle} (Equation 3)

Alternatively, however, as appreciated by those skilled in the art, the weight W_{vehicle} of the vehicle can also be determined directly through the use of load sensors and similar devices capable of sensing the vehicle's weight and forces.

The VSC then determines if the estimated vehicle weight W_{vehicle} is greater than or equal to a predetermined weight constant Wₛₑₜ (Step 512). The predetermined threshold vehicle weight value Wₛₑₜ can be determined experimentally, but preferably is set equal to the approximate weight of the vehicle in an unloaded state, i.e., meaning it is the baseline weight of the vehicle with a nominal number of passengers and nominal cargo or towing load. The threshold vehicle weight Wₛₑₜ can also be set according to desired drivability characteristics and expected loading conditions. If the estimated vehicle weight W_{vehicle} is less than a predetermined weight constant Wₛₑₜ, the VSC exits the control strategy. However, if the estimated vehicle weight W_{vehicle} is greater than or equal to a predetermined weight constant Wₛₑₜ, then the VSC determines whether or not the driver torque request τ_{req} is greater than or equal to a predefined torque constant τₛₑₜ (Step 514). In a one embodiment, the torque constant is approximately equal to a maximum torque output capacity of the motor. In another embodiment, the torque constant is nominally 50-70% of the maximum torque output of the powertrain.

Referring again to FIG. 5, if the torque request τ_{req} is less than the predefined torque constant τₛₑₜ, then the VSC exits the control strategy. If the driver torque request τ_{req}, however, is greater than or equal to the predefined torque constant τₛₑₜ, then the VSC initiates the start up of the internal combustion engine (Step 516).

Although the present invention has been described in connection with particular embodiments thereof, it is to be understood that various modifications, alterations and adaptations may be made by those skilled in the art without departing from the spirit and scope of the invention. It is intended that the invention be limited only by the appended claims.

1. A system for propelling a vehicle, comprising:
a primary power source for propelling the vehicle at a time after the vehicle is initially propelled;
a secondary power source for initially propelling and accelerating the vehicle prior to activation of the primary power source; and
a controller for determining a weight of the vehicle based on initial acceleration of the vehicle, for determining a driver torque request, and for activating the primary power source when the weight of the vehicle exceeds a predetermined threshold vehicle weight value and the driver torque request exceeds a predetermined threshold torque value.

2. The system according to claim 1, wherein the primary power source comprises an internal combustion engine.

3. The system according to claim 1, wherein the primary power source comprises a fuel cell engine.

4. The system according to claim 1, wherein the secondary power source comprises an electrical storage device coupled to at least one electric machine.

5. The system according to claim 1, wherein the controller further comprises means for estimating the weight of the vehicle as a function of an operating parameter of the secondary power source.

6. The system according to claim 1, wherein the controller further comprises means for estimating the weight of the vehicle as a function of an initial acceleration of the vehicle.

7. The system according to claim 1, wherein the controller further comprises means for estimating an initial acceleration of the vehicle.

8. The system according to claim 1, wherein the controller further comprises means for estimating the weight of the vehicle as a function of a traction force at drive wheels of the vehicle.

9. The system according to claim 1, wherein the secondary power source further comprises a plurality of electric machines, and wherein the weight determining step comprises the step of estimating a traction force at drive wheels of the vehicle based on torque delivered by the plurality of the electric machines.

10. A method of operating a vehicle having a plurality of power sources for propelling the vehicle, the method comprising:
using one of the power sources to initially accelerate the vehicle;
determining a weight of the vehicle based on initial acceleration of the vehicle;
determining a driver torque request; and
activating another of the power sources when the weight of the vehicle exceeds a predetermined threshold vehicle weight value and the driver torque request exceeds a predetermined threshold torque value.

11. The method according to claim 10, wherein the step of using one of the power sources to initially accelerate the vehicle comprises using one of the power sources as a secondary power source of the vehicle to initially accelerate the vehicle; and wherein the activating step comprises using another of the power sources as a primary power source of the vehicle.

12. The method according to claim 11, wherein the primary power source comprises an internal combustion engine.

13. The method according to claim 11, wherein the primary power source comprises a fuel cell engine.

14. The method according to claim 11, wherein the secondary power source comprises an electrical storage device coupled to at least one electric motor.

15. The method according to claim 10, wherein the weight determining comprises the step of estimating the weight as a function of an operating parameter of the one of the power sources used to initially accelerate the vehicle.

16. The method according to claim 10, wherein the weight determining step comprises the step of estimating an initial acceleration of the vehicle.

17. The method according to claim 10, wherein the weight determining step comprises the step of estimating a traction force at drive wheels of the vehicle.

18. A method for minimizing user-discernible ride inconsistency attributable to starting of an internal combustion engine of a vehicle having at least an internal combustion engine and an electrically powered motor, the method comprising:
determining a weight of the vehicle;
comparing the weight of the vehicle with a predetermined threshold vehicle weight value;
generating a driver torque request;
comparing the driver torque request with a predetermined threshold torque value; and
starting the engine when the weight of the vehicle is greater than the predetermined threshold vehicle weight value and the driver torque request is greater than the predetermined threshold torque value, the starting of the engine being controlled to occur when the motor has sufficient torque capacity to be controlled in a manner that negates opposing torque effects imposed by the starting of the engine.

19. The method according to claim 18, further comprising the step of controlling a generator to cooperate with the motor to start the engine, the generator being connected to the engine via a planetary gear set.

20. The method according to claim 18, further comprising the step of quantifying the predetermined threshold vehicle weight value to be approximately equal to the weight of the vehicle in an unloaded state.

21. The method according to claim 18, further comprising the step of quantifying the predetermined threshold torque value to be approximately equal to a maximum torque output capacity of the motor.

22. The method according to claim 18, further comprising the steps of:
determining whether the engine is in a running state;
proceeding with the comparing steps when the engine is not in a running state; and
terminating the comparing steps when the engine is in a running state.

23. The method according to claim 18, wherein the weight determining step comprises the step of estimating the weight of the vehicle based on an initial acceleration of the vehicle.

24. The method according to claim 18, wherein the weight determining step comprises the step of estimating the weight of the vehicle based on a traction force experienced at drive wheels of the vehicle.

25. The method according to claim 18, wherein the vehicle further comprises a generator for cooperating with the motor to start the engine, and wherein the weight determining step comprises the step of estimating a traction force at drive wheels of the vehicle based on a motor-delivered torque and a generator-delivered torque.
